(19) United States
(12) Patent Application Publication
(10) Pub. No.: US 2015/0356276 A1
(43) Pub. Date: Dec. 10, 2015

(54) EQUATIONS DESCRIBING THE STRUCTURAL FLUCTUATION AND DYNAMICS OF BIOPOLYMERS IN SOLUTION

(71) Applicant: MOLECULAR DESIGN FRONTIER CO., LTD., Otsu-shi, Shiga (JP)

(72) Inventors: Fumio HIRATA, Otsu-shi, Shiga (JP); Bongsoo KIM, Gimhae-shi (KR)

(73) Assignee: MOLECULAR DESIGN FRONTIER CO., LTD., Otsu-shi, Shiga (JP)

(21) Appl. No.: 14/762,918

(22) PCT Filed: Nov. 25, 2013
(86) PCT No.: PCT/JP2013/081601

§ 371 Date: Jul. 23, 2015

(30) Foreign Application Priority Data
Jan. 23, 2013 (JP) PCT/JP2013/051940

(51) Int. Cl. G06F 19/00

(52) U.S. Cl. CPC G06F 19/701

(57) ABSTRACT

The applicant devised a novel theoretical means for determining a variance-covariance matrix of the structural fluctuation of a biopolymer by deriving, on the basis of the equilibrium and non-equilibrium statistical mechanics of liquids, two theoretical formulae that are set forth in claim 1 of the present application [(1) the fluctuation and dynamics of the biopolymer, and (2) the density fluctuation and dynamics of solvent], analyzing these equations, and then second order differentiating the free energy surface of the biopolymer in a solution with respect to the atomic coordinate thereof. The present invention enables an atomic level analysis of the liquid structure and density fluctuation of a complex aqueous solution system that contains ions and other small molecules. Further, the present invention enables highly accurate atomic level prediction and description of the effects thereof on the structural fluctuation and dynamics of biopolymers. Therefore, applications of the present invention, such as a method of searching for a high-affinity ligand, a method for designing a drug candidate compound, a method for designing a novel functional material and a method for intellectually designing a molecule in the course of prediction and development, can largely contribute to the progress in the fields of medicine and nanotechnology.

This application is the national phase under 35 U.S.C. §371 of PCT International Application No. PCT/JP2013/81601 which has an International filing date of Nov. 25, 2013 and designated the United States of America.

### BACKGROUND

1. Technical Field

The present invention relates to equations and computational algorithms for describing structural fluctuation and dynamics of biopolymers at the atomic level, which are conjugated with the density (concentration) fluctuation of solution.

2. Description of Related Art

The structural fluctuation and dynamics of biopolymers in solution is related to their functions, thereby many theoretical and computational methodologies have been proposed. It is because the structural fluctuation and dynamics of biopolymers (especially, protein) are crucial factors to govern their functions such as enzymatic activity. Moreover, those are practical issues for discovery of a new drug, that has attracted serious attention of the human society. The reason why the structural fluctuation and dynamics of biopolymers are so important in drug design is because they play essential roles in binding of drug compounds to a target molecule (protein or DNA).

The earliest method that has been proposed to describe the structural fluctuation and dynamics of biopolymers is based on the normal mode analysis for protein. Unfortunately, the method is concerned with a protein in “vacuum,” which does not include water serving as solvent. Therefore, the “structural fluctuations” are just “non-biological” ones, which are not capable of describing “biological” fluctuations of protein in vivo. On the other hand, several methodologies that have their basis on phenomenological consideration on solvent, such as Poisson-Boltzmann equation and Langevin equation, have been proposed. However, those methods are not able to explain the factors which give essential influence on the structural fluctuation of protein, such as hydration and dehydration, associated with binding of a ligand to an active site of protein, since they disregard the structure of solvent at the molecular level. Alternatively, the so-called molecular simulations, such as molecular dynamics and Monte-Carlo method, have been popularly employed in these days to describe the structural fluctuation of protein. Although the methods are quite effective to explain relatively small structural fluctuations of protein, it has a serious technical difficulty in terms of the system size and the time scale of the fluctuations in order to describe the collective mode conjugated with the density fluctuation of solvent. Especially, the most serious difficulty in the molecular simulations is that the method is almost useless for a system including ions other than water and other small molecules in solution. It is because the time required for ions and so on to diffuse in solution is far longer than the integral time step of Newton equation, and thereby the simulation does not converge within finite computation time.

### SUMMARY OF THE INVENTION

The drawback of the conventional theories and methods of describing the structural fluctuation and dynamics of biopolymers originates from their disregarding of the liquid structure and density fluctuation of solvent.

It is the problem that this invention is trying to solve. The present invention proposes a method to describe the structural fluctuation and dynamics of biopolymers, taking account for the liquid structure and density fluctuation of solvent at the atomic level.

The method to solve the problem is obtained based on theories for liquid in the equilibrium statistical mechanics (the 3D-RISM/RISM theory) and in the non-equilibrium statistical mechanics (the generalized Langevin theory). By combining the theories, we derived new equations to describe the fluctuation and dynamics of biopolymers in solution.

$$\begin{matrix}{M}_{α} \frac{{d}^{2} Δ {R}_{α} ( t )}{d {t}^{2}} = - {k}_{B} T {\sum }_{β} {( {L}^{- 1} )}_{α β} \cdot Δ {R}_{β} ( t ) - {\int }_{0}^{t} d s {\sum }_{β} {Γ}_{α β} ( t - s ) \cdot \frac{{P}_{β} ( s )}{{M}_{β}} + {W}_{α} ( t ) & ( 1 ) \\ \frac{{d}^{2} δ {ρ}_{k}^{a} ( t )}{d {t}^{2}} = - {k}^{2} {\sum }_{b , c} {J}_{a c} ( k ) {χ}_{cb}^{- 1} ( k ) δ {ρ}_{k}^{b} ( t ) - \frac{i k}{N} \sum {J}_{a c}^{- 1} ( k ) {\int }_{0}^{t} d {sM}_{k}^{bc} ( t - s ) \cdot {J}_{k}^{b} ( s ) + ik \cdot {Ξ}_{k}^{a} ( t ) & ( 2 )\end{matrix}$$

Eq. (1) describes the structural fluctuation and dynamics of biopolymers. Each of symbols in the equation has the following physical meaning.

ΔR_{α}(t): the displacement (fluctuation) of atomic coordinate in biopolymer from their equilibrium position

M_{α}: mass of the atom α in biopolymer

Γ_{αβ}: frictional force acting on biopolymer atoms

W_{α}(t): random force acting on biopolymer atoms

The first term in the right hand side of Eq. (1) represents restoring force proportional to the displacement (fluctuation of atomic coordinate). We discovered that the matrix L included in the coefficient of the term takes the following expression.

L_{αβ}= [symbol] ΔRΔR [symbol] _{αβ} (3)

ΔR in Eq. (3) is the displacement (fluctuation) of atomic coordinate in biopolymer from their equilibrium position in the equilibrium state. Therefore, the matrix L represents the variance-covariance matrix of structural fluctuation.

Eq. (2) is an equation describing the density fluctuation and dynamics of solvent around a biopolymer. Each of the symbols in the equation has the following physical meaning.

δρₖ^{a}(t): deviation of solvent atom density around a biopolymer from bulk density

J_{ac}(k): correlation of momentum density between a pair of atoms in solvent in the equilibrium state

χ_{cb}(k): density correlation function between a pair of solvent atoms in the equilibrium state

Mₖ^{bc}(t−s): frictional force acting on solvent atoms

Ξₖ^{a}(t): random force acting on solvent atoms

The above Eq. (1) has a form of the generalized Langevin equation. If one disregards the second (friction) and the third (random force) terms in the right hand side of the equation, it takes a form similar to a harmonic oscillator. Then, the first term in the right hand side can be physically interpreted as a “restoring force” proportional to the displacement (R) of atoms in biopolymer from their equilibrium positions, and the proportional constant can be regarded as a “force constant” (Hessian) of the harmonic oscillator. On the other hand, the dynamics of a biopolymer, described by the equation, is a fluctuation around its equilibrium structure (the minimum point of free energy surface). Therefore, the proportional constant stated above has the physical meaning that is the second derivative of the free energy surface with respect to the atomic displacement. (In the case of a harmonic oscillator, it is the second derivative of the potential energy between atoms.) From the consideration, we have discovered the following expression.

$${〈 Δ R Δ R 〉}_{α β} = {k}_{B} {T ( \frac{{\partial }^{2} F ( \{ Δ R \} )}{\partial Δ {R}_{α} \partial Δ {R}_{β}} )}^{- 1} \qquad ( 4 )$$

{ΔR} that is an argument of F({ΔR}) in Eq. (4) represents the deviation of all atomic coordinates in biopolymer positions from their equilibrium structure. According to the equation, the problem to find the variance-covariance matrix of the structural fluctuation of protein is reduced to the calculation of the free energy surface F({ΔR}) of biopolymer in solution. F({ΔR}) is defined as a sum of the interaction energies of atoms in protein and the solvation free energies. One of the applicants has already proposed a method to calculate F({ΔR}) based on the 3D-RISM/RISM theory, and the computational algorithm to obtain the variance-covariance matrix of the structural fluctuation of biopolymers has been already established.

One of the problems to which the present invention is expected to make an advantageous effect is the induced fitting of a ligand (drug molecule) to a protein. The binding affinity of a ligand to a protein is primarily determined by the free energy difference before and after the binding. However, it is well regarded in many proteins that the fluctuation of amino-acid residues consisting the mouth of the ligand binding site to a protein, or the open and close motions of the mouth, gives significant effect on the binding affinity of a ligand. A useful following equation that can be applied to such a problem has been already proposed by Ikeguchi et al. of Yokohama City University, based on the linear response theory.

$${〈 Δ {R}_{α} 〉}_{1} = {( {k}_{B} T )}^{- 1} {\sum }_{β} {〈 Δ {R}_{α} Δ {R}_{β} 〉}_{0} \cdot {f}_{β}$$

In the equation, f_{β} is a perturbation associated with ligand binding, <ΔR_{α}>₁ is the structural change of a protein, or displacement of each atom, induced by the perturbation, and the response function is the variance-covariance matrix <ΔR_{α} ΔR_{β}>₀. The conventional method has employed the molecular dynamics simulation to determine the variance-covariance matrix. However, as described above, the method cannot describe large fluctuation (collective modes) of a protein, and cannot treat a system in which ions and other small molecules are included in solvent. On the other hand, according to Eq. (4) in this application, the variance-covariance matrix can be obtained by taking the second derivative of the free energy surface of protein with respect to the atomic coordinates. That lets our method solve the problem of induced-fitting of a ligand to a protein, since the free energy surface of protein can be readily obtained from the 3D-RISM/RISM program, the copy right of which is owned by one of the applicants.

The above and further objects and features of the invention will more fully be apparent from the following detailed description with accompanying drawings.

### BRIEF DESCRIPTION OF THE SEVERAL VIEWS OF THE DRAWINGS

FIG. 1 illustrates the procedure of numerical calculation in the central column, and the input and output data flows in the right and left columns, in which the arrows between the central column and the right (or left) column indicate the directions of data flow between the computer-processor unit and the data storage unit;

FIG. 2 is a schematic view that illustrates the appearance of the information processing device;

FIG. 3 is a block diagram that illustrates an example of the information processing device; and

FIG. 4 is a flow chart showing an example of the protocol that the controlling unit processes.

### DETAILED DESCRIPTION

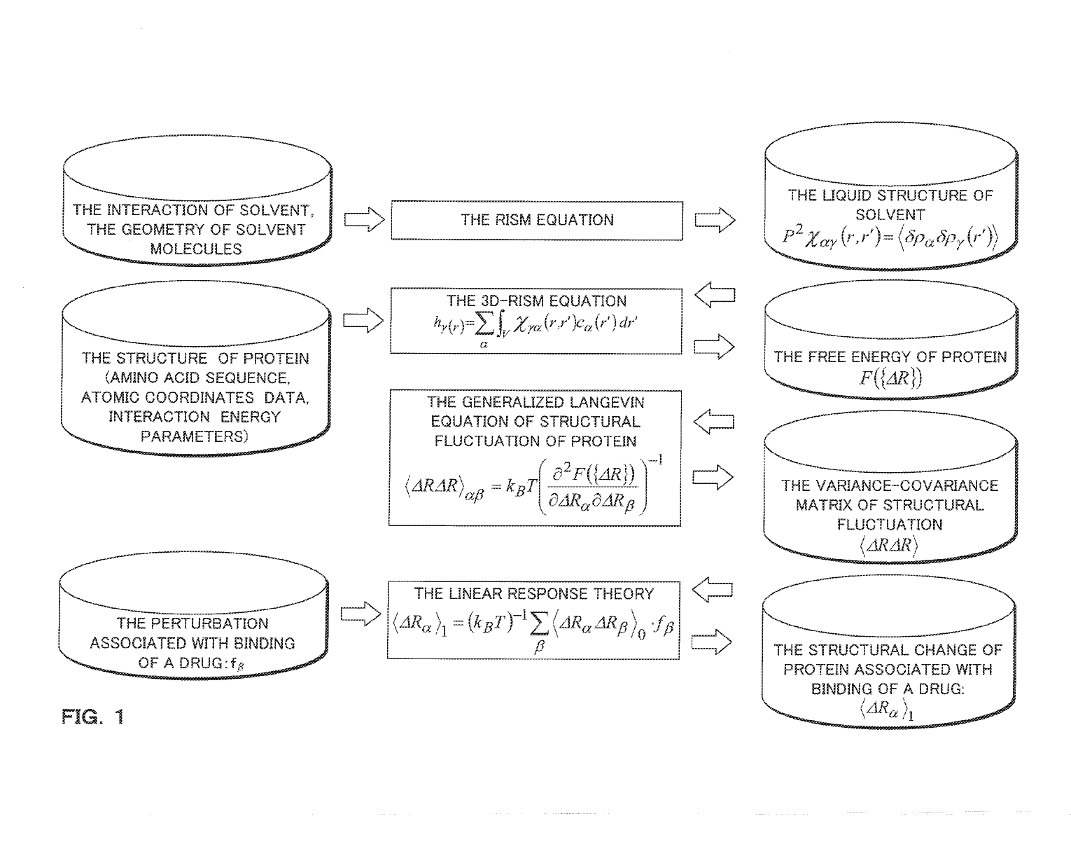

The invention is embodied as a computer science, and the equations proposed in the application are solved numerically by computer. In FIG. 1, a flow chart of the calculation with respect to the above-mentioned “induced fitting” of a ligand to a protein is shown as an example.

### (Step 1)

The correlation functions of solvent density fluctuation, χ_{αγ}(r, r′), is calculated by solving the RISM equation, using information of the interaction between solvent molecules and of their geometry as input data.

### (Step 2)

The 3D-RISM equation is solved by inputting the structural information of protein (amino acid sequence, atomic coordinates data, interaction energy parameters, etc.) and χ_{αγ}(r, r′) obtained in Step 1 into the equation. The procedure gives rise to the density distribution (h_{γ}(r)) of solvent molecules around protein, and the free energy F({ΔR}).

### (Step 3)

The variance-covariance matrix <ΔR ΔR> of structural fluctuation is obtained by taking the second derivative of the free energy F({ΔR}), which is obtained in Step 2, with respect to the atomic coordinate of protein.

### (Step 4)

The structural change of protein induced by a perturbation is calculated by means of the linear response theory, with a perturbative force f associated with binding of a drug and <ΔR ΔR> obtained in (Step 3) as an input.

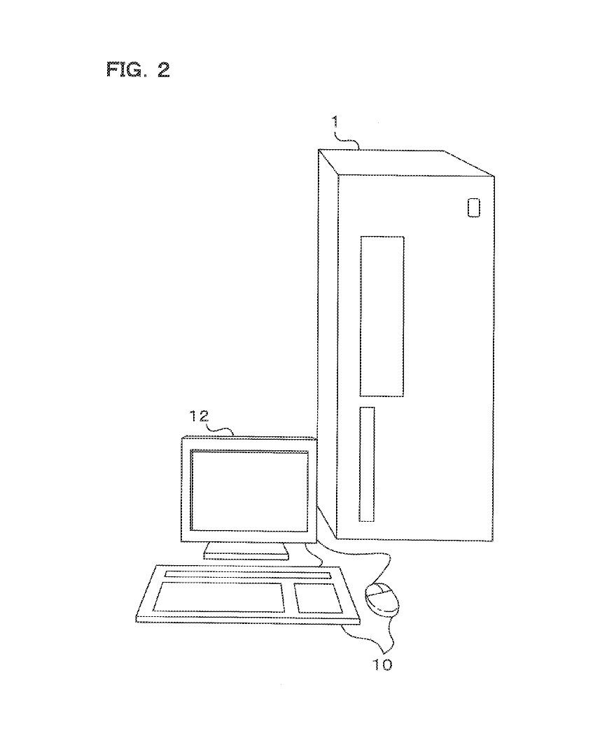

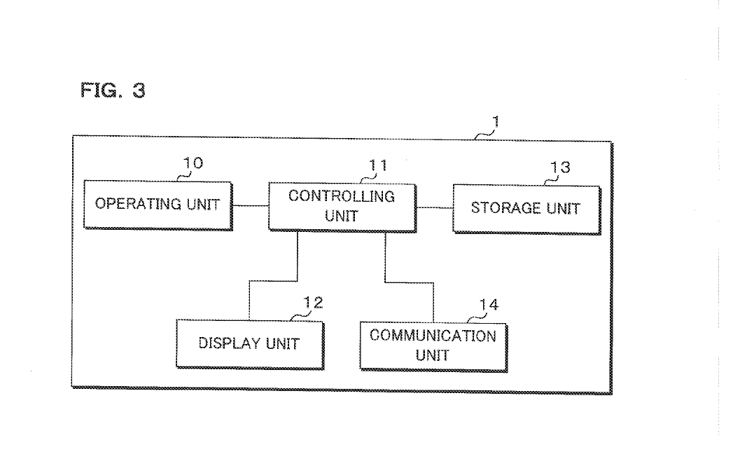

Information processing device is shown in FIG. 2 and FIG. 3 as an example of a computer which carries out the calculation described above.

FIG. 2 is a schematic view that illustrates an appearance of the information processing device 1. FIG. 3 is a block diagram which shows an example of the structure of information processing device 1. The information processing device 1 includes an operating unit 10, a controlling unit 11, a display unit 12, a storage unit 13, and a communication unit 14.

The operating unit 10 has a variety of hard keys, such as a starting key, a function key and a numeric keypad, and a mouse. The operating unit 10 receives an operation for the information processing device 1 by a user.

The controlling unit 11 includes a microcomputer which has a central processing unit (CPU), a recording medium (read only memory: ROM), a memory (random access memory: RAM), etc. It controls the behavior of each component of the information processing device 1, by providing a control signal to the each component in response to operations received by the operating unit 10.

The display unit 12 is made by a liquid-crystal panel, and it displays an image based on a control signal provided from the controlling unit 11. It may also be made by a plasma display panel, an organic EL panel or the like.

The storage unit 13 includes RAM, and stores, for example, the mathematical equations to be used for the calculation according to the invention, and a computer program making the information processing device 1 execute the calculation according to the invention. The storage unit 13 stores information concerning the interaction and geometry of solvent molecules. The storage unit 13 may serve as a memory device which reads the computer program and the mathematical equations etc. to be used in the Step 1-4 described above, from the recording medium recording therein the computer program and the mathematical equations etc., and stores them. The storage unit 13 also may work as a device which gets information of the interaction between solvent molecules and of their geometry from an external device through the communication unit 14 described later. Further, the storage unit 13 can be constituted by a storage medium other than the RAM, for example, HDD.

The communication unit 14 includes the Ethernet (registered trademark) connection ports, and communicates with external devices through a communication network, such as the Internet. For example, the structural information of protein to be input in Step 2 is obtained from a website such as Protein Data Bank Japan (PDBj) through the communication unit 14. The structural information of protein can also be stored in the storage unit 13 in advance without accessing the communication unit 14.

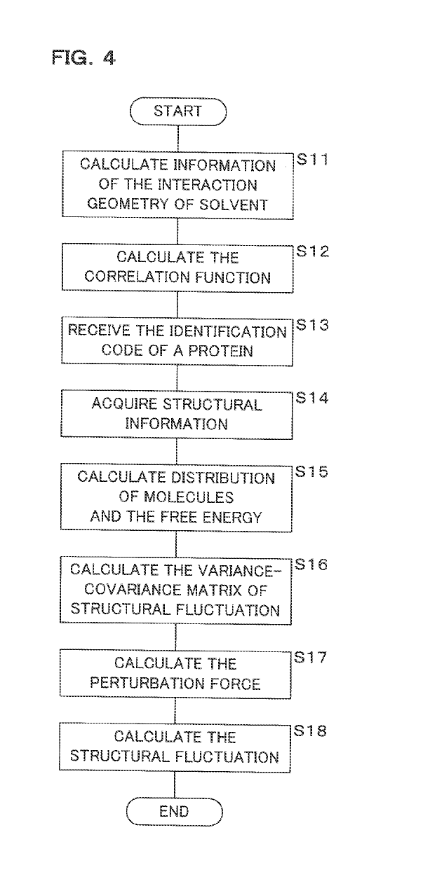

FIG. 4 is the flow chart showing an example of the procedure carried out by the controlling unit 11. In the following, we explain an example of calculating the structural fluctuation of lysozyme in the case where a prescribed compound is provided as a drug in a situation where lysozyme is employed as protein and water is employed as solvent.

The controlling unit 11 receives information concerning water as a solvent through the operating unit 10. Based on the received information, the controlling unit 11 calculates information of the interaction between water molecules and of their geometry (step S11). The controlling unit 11 inputs the calculated information of interaction and geometry into the RISM equation, and solves the equation to calculate the correlation functions (χ_{αγ}(r, r′)) of density fluctuation in water solvent (step S12).

The controlling unit 11 receives the identification code of lysozyme as a protein through the operating unit 10 (step S13). Based on the received identification code, the controlling unit 11 acquires structural information of lysozyme concerning the amino acid sequence, atomic coordinate data, interaction energy parameters and the like from the storage unit 13 (step S14).

The controlling unit 11 inputs the calculated correlation function (χ_{αγ}(r,r′)) and the acquired structural information of lysozyme into the 3D-RISM equation, and solves the equation to calculate distribution (h_{γ}(r)) of water molecules around lysozyme and the free energy (F(Δ{R})) (step S15).

The controlling unit 11 calculates the variance-covariance matrix (<ΔRΔR>) of structural fluctuation of lysozyme by taking the second derivative of the calculated free energy (F(Δ(R)) with respect to the atomic coordinates of lysozyme (step S16).

The controlling unit 11 calculates, through the operating unit 10, the perturbation force f which may be caused by binding of the prescribed compound, regarded as a drug, to lysozyme (step S17). The controlling unit 11 calculates the structural fluctuation of lysozyme, by inputting the calculated perturbation force f and the calculated variance-covariance matrix (<ΔRΔR>) into the linear response theory to calculate the displacement of atoms of lysozyme induced by the perturbation (step S18). The controlling unit 11 makes the display unit 12 display the results of calculation, and terminates the processing.

It is possible to obtain information which indicates, for example, whether the lysozyme binds to a prescribed compound or not, by analyzing the structural fluctuation of lysozyme resulted from calculation. Therefore, a great contribution by the present invention to such technologies as ligand search and drug design for biopolymers like protein, and as the new material discovery is expected.

### INDUSTRIAL APPLICABILITY

As industrial applicability of the present invention, the most promising subject is “target search” and “screening of drug-candidate compounds” in the discovery of new drugs.

### (Target Search)

The first step of drug discovery starts from searching protein and DNA as a target of the drug compound. Currently, the process is carried out thoroughly by means of physiological and/or biochemical experiments. The purpose of those experiments is to investigate functions of biomolecules that are related to disease one way or the other. Any function of biomolecules, such as catalyst and signal transduction, involves the molecular recognition process, or the binding of a ligand to a biomolecule, as an elementary process. Therefore, the most crucial process in the target search of drug compounds is nothing but the molecular recognition process, or analyzes of binding affinity of substrate molecules (or ligand) to the target molecule. The 3D-RISM/RISM theory, one of the bases of the present application, provides a powerful weapon to investigate the binding affinity of a ligand to a target protein, the structure of which is fixed. However, the method cannot be applied to a case in which the structural fluctuation plays a crucial role, such as the induced fitting process. The invention of the present application provides a new computational method that can be applied to such a process in which the structural fluctuation of the target protein plays an essential role.

### (Screening of Drug-Candidate Compounds)

Another important process in the drug discovery is to search a compound that inhibits or promote functions of a target protein or DNA most efficiently. In the process, too, one has to analyze the molecular recognition process of a candidate compound by a target protein. Although it is the free energy change associated with a candidate compound binding by a target protein that primarily determines the molecular recognition process, at the same time, there are many cases where the structural fluctuation of protein plays a crucial role. The method proposed in this invention is an effective mean to analyze the binding affinity of a compound to a target, in which the structural fluctuation plays an essential role.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1-8. (canceled)

9. A structural fluctuation calculating device for calculating a structural fluctuation occurring in a protein in a state where the protein and a solvent are present, comprising
a calculating section for calculating a density correlation function between any pair of atoms included in molecules constituting the solvent based on an interaction between the molecules and on a geometry of the molecules, wherein
the calculating section calculates a free energy of a molecule of the protein based on the density correlation function and structural information representing a structure of the protein, and
the calculating section calculates a variance-covariance matrix of structural fluctuation of the protein by taking the second derivative of the free energy with respect to atomic coordinates of the protein represented by the structural information.

10. The structural fluctuation calculating device according to claim 9,
wherein the calculating section calculates the variance-covariance matrix by using an equation (1).
$${〈 Δ R Δ R 〉}_{α β} = {k}_{B} {T ( \frac{{\partial }^{2} F ( \{ Δ R \} )}{\partial Δ {R}_{α} \partial Δ {R}_{β}} )}^{- 1} \qquad ( 1 )$$
ΔR: displacement of atomic coordinates in the protein from their equilibrium position in the equilibrium state
F({ΔR}): free energy surface of the molecule of the protein in the solvent
α: an atom selected from all atoms in the molecule of the protein
β: an atom which is selected from all atoms in the molecule of the protein and is different from α
ΔR_{α}: displacement of α-atom
ΔR_{β}: displacement of β-atom
<ΔR ΔR>_{αβ}: the variance-covariance matrix of the structural fluctuation concerning the α-atom and β-atom
k_{B}: Boltzmann constant
T: temperature of the protein

11. A structural fluctuation calculating method for calculating a structural fluctuation occurring in a protein in a state where the protein and a solvent are present, comprising:
calculating a density correlation function between any pair of atoms included in molecules constituting the solvent based on an interaction between the molecules and on a geometry of the molecules;
calculating a free energy of a molecule of the protein based on the density correlation function and structural information representing a structure of the protein; and
calculating a variance-covariance matrix of structural fluctuation of the protein by taking the second derivative of the free energy with respect to atomic coordinates of the protein represented by the structural information.

12. The structural fluctuation calculating method according to claim 11, wherein the variance-covariance matrix is calculated by using an equation (1).
$${〈 Δ R Δ R 〉}_{α β} = {k}_{B} {T ( \frac{{\partial }^{2} F ( \{ Δ R \} )}{\partial Δ {R}_{α} \partial Δ {R}_{β}} )}^{- 1} \qquad ( 1 )$$
ΔR: displacement of atomic coordinates in the protein from their equilibrium position in the equilibrium state
F({ΔR}): free energy surface of the molecule of the protein in the solvent
α: an atom selected from all atoms in the molecule of the protein
β: an atom which is selected from all atoms in the molecule of the protein and is different from α
ΔR_{α}: displacement of α-atom
ΔR_{β}: displacement of β-atom
<ΔR ΔR>_{αβ}: the variance-covariance matrix of the structural fluctuation concerning the α-atom and β-atom
k_{B}: Boltzmann constant
T: temperature of the protein

13. A non-transitory recording medium in which a computer program is recorded, the computer program making a computer calculate a structural fluctuation occurring in a protein in a state where the protein and a solvent are present, the computer program comprising the steps of:
calculating a density correlation function between any pair of atoms included in molecules constituting the solvent based on an interaction between the molecules and on a geometry of the molecules;
calculating a free energy of a molecule of the protein based on the density correlation function and structural information representing a structure of the protein; and
calculating a variance-covariance matrix of structural fluctuation of the protein by taking the second derivative of the free energy with respect to atomic coordinates of the protein represented by the structural information.

14. The non-transitory recording medium according to claim 13, wherein the computer program making the computer calculate the variance-covariance matrix by using an equation (1) is recorded.
$${〈 Δ R Δ R 〉}_{α β} = {k}_{B} {T ( \frac{{\partial }^{2} F ( \{ Δ R \} )}{\partial Δ {R}_{α} \partial Δ {R}_{β}} )}^{- 1} \qquad ( 1 )$$
ΔR: displacement of atomic coordinates in the protein from their equilibrium position in the equilibrium state
F({ΔR}): free energy surface of the molecule of the protein in the solvent
α: an atom selected from all atoms in the molecule of the protein
β: an atom which is selected from all atoms in the molecule of the protein and is different from α
ΔR_{α}: displacement of α-atom
ΔR_{β}: displacement of β-atom
<ΔR ΔR>_{αβ}: the variance-covariance matrix of the structural fluctuation concerning the α-atom and β-atom
k_{B}: Boltzmann constant
T: temperature of the protein
